(19) United States
(12) Patent Application Publication
(10) Pub. No.: US 2021/0337749 A1
(43) Pub. Date: Nov. 4, 2021

(54) IRRIGATION APPARATUS AND FEEDING SYSTEM

(71) Applicant: 4D Holdings, LLC, Studio City, CA (US)

(72) Inventor: Aaron Marshall, Studio City, CA (US)

(21) Appl. No.: 17/375,917

(22) Filed: Jul. 14, 2021

Related U.S. Application Data
(62) Division of application No. 14/675,907, filed on Apr. 1, 2015.
Application No. 14/675,907 is a continuation-in-part of application No. 14/488,009, filed on Sep. 16, 2014, now abandoned.
Application No. 14/488,009 is a continuation-in-part of application No. 14/245,731, filed on Apr. 4, 2014, now abandoned.

(51) Int. Cl. A01G 27/00

(52) U.S. Cl. CPC A01G 27/00

(57) ABSTRACT

An irrigation apparatus for dispersing liquid through a plant growing medium is disclosed. The apparatus includes a geometrically shaped container of variable size. The container has an outer wall with an inner surface, an open top, and a base portion configured to cover the plant growing medium. The base portion is configured with multiple holes for receiving liquid therethrough, The holes are configured as raised half-circles to block light and receive air, water, and nutrients. The container is configured with at least one center opening therethrough having an inner wall for receiving a plant. The center opening has at least one longitudinal opening extending therefrom to outer wall to allow placement of container on plant or to allow removal of container from plant. The container is configured with multiple stakes of variable size extending therefrom the base portion for providing stability for apparatus to be secured in plant growing medium.

### CROSS-REFERENCE TO RELATED APPLICATIONS

This is a division application of U.S. patent application Ser. No. 14/675,907, filed Apr. 1, 2015, which is a continuation-in-part application of U.S. patent application Ser. No. 14/488,009, filed Sep. 16, 2014, which is a continuation-in-part application of U.S. patent application Ser. No. 14/245,731, filed Apr. 4, 2014, which is incorporated herein by reference in its entirety.

### TECHNICAL FIELD

The present invention relates to the field of horticultural irrigation apparatus and watering systems, and more particularly, to an automated irrigation apparatus and system for feeding or watering plants and the like.

### BACKGROUND

Plants typically require feeding or watering or otherwise supplementing with liquid nutrition at least once weekly to survive. During occasions when an individual plans to be away from home for an extended period of time, the individual needs to make arrangements for the care of his or her plants. This involves the cost and inconvenience of hiring help to care for the plants and compromises the individual's privacy in the home or personal space.

Various self-watering plant watering or feeding apparatus and systems have been developed, but such apparatus and systems are not specifically designed for simple, convenient, and economical use due to their complex construction, and are not easily adaptable to an existing plant container or medium. It would thus be desirable to have an improved automated irrigation apparatus and system for feeding or watering plants and the like, which avoids the disadvantages of the known apparatus and systems.

### SUMMARY

In a first aspect, there is provided herein an irrigation apparatus for dispersing liquid through a plant growing medium. The apparatus includes a geometrically shaped container of variable size having an outer wall with an inner surface, an open top, and a base portion configured to cover the plant growing medium. The base portion is configured with a plurality of holes for receiving liquid therethrough. The container is configured with at least one center opening therethrough having an inner wall for receiving a plant. The at least one center opening has at least one longitudinal opening extending therefrom to the outer wall to allow placement of the container on the plant or to allow removal of the container from the plant. The container is configured with a plurality of geometrically shaped stakes of variable size extending therefrom the base portion for providing stability for the apparatus to be secured in the plant growing medium.

In certain embodiments, the plurality of holes are configured as raised half-circles or louvers to block light and receive air, water, and nutrients.

In certain embodiments, each corner of the base portion is configured with a hole to aid in the drainage of liquid from the container.

In certain embodiments, the container is configured with at least one hinge at a first end such that the container is opened and closed at a second end along with at least one of a clip or clamp via one male to one female ratio or other combinations of male to female ratios.

In certain embodiments, the outer wall of the container may be optionally configured with an adapter connectable to a variable size nozzle via a thread cap for use with a hose or pump system.

In certain embodiments, the container may be fabricated of a combination of translucent and opaque materials as separate parts or as an over mold that can be molded together such that the outer wall is translucent and the base portion is opaque for blocking light to the plant growing medium.

In certain embodiments, the at least one longitudinal opening is configured with an overhang lip portion at opposing sides for blocking light to the plant growing medium.

In a second aspect, there is provided herein an irrigation apparatus for dispersing liquid through a plant growing medium. The apparatus includes a geometrically shaped container of variable size having an outer wall with an inner surface, an open top, and a base portion configured to cover the plant growing medium. The base portion is configured with a plurality of holes for receiving liquid therethrough. The container is configured with at least one center opening therethrough having an inner wall for receiving a plant. The at least one center opening has at least one longitudinal opening extending therefrom to the outer wall to allow placement of the container on the plant or to allow removal of the container from the plant. The plurality of holes are configured with at least one dripper for receiving liquid extending therethrough the base portion such that the at least one dripper feeds the plant growing medium at variable flow rates and intervals and provides stability for the apparatus to be secured in the plant growing medium.

In certain embodiments, the container may be configured with an overhang lip portion formed around a top edge of the outer wall for blocking light to the plant growing medium.

In certain embodiments, the overhang lip portion is configured with a plurality of geometrically shaped louvers of variable size for blocking light to the plant growing medium while allowing air to pass through.

In certain embodiments, the plurality of geometrically shaped louvers may be configured to receive at least one barbed louver insert for providing compatibility of the apparatus for use with an irrigation feeding system such that the barbed louver insert is configured to connect to a hose.

In certain embodiments, the plurality of holes may be configured to receive at least one plug having at least one hole for receiving liquid therethrough.

In a third aspect, there is provided herein an irrigation apparatus for dispersing liquid through a plant growing medium. The apparatus includes a geometrically shaped top of variable size configured with a plurality of holes for receiving liquid therethrough. The top is configured with at least one center opening therethrough having an inner wall for receiving a plant. The at least one center opening has at least one longitudinal opening extending therefrom to an outer wall to allow placement of the top on the plant or to allow removal of the top from the plant. The plurality of holes are configured with at least one dripper for receiving liquid extending therethrough the top such that the at least one dripper feeds the plant growing medium at variable flow rates and intervals and provides stability for the apparatus to be secured in the plant growing medium.

In certain embodiments, the plurality of holes are configured with an over mold ring disposed therearound for providing an improved seal and interchangeability of the at least one dripper into the top.

In certain embodiments, the over mold ring is fabricated from a rubber material or any suitable elastic polymeric material.

In a fourth aspect, there is provided herein a dripper for use with an irrigation feeding system for dispersing liquid through a plant growing medium. The dripper includes an emitter top plug having a top surface and a bottom surface and a nozzle having a first end and a second end. The first end is configured to be affixed to the top surface of the emitter top plug. The dripper further includes a variable emitter path section having at least one torturous path to control liquid flow and an emitter bottom plug having at least one hole to discharge liquid therefrom. The emitter top plug and the emitter bottom plug are configured to encase the variable emitter path section. The dripper further includes a longitudinal exterior emitter plunger having an outer surface configured with a plurality of holes for dispersing liquid therethrough. The exterior emitter plunger is configured to attach to the emitter bottom plug.

In certain embodiments, the longitudinal exterior emitter plunger may be configured with a break section for directing liquid to various points of a root zone within the plant growing medium.

In certain embodiments, the dripper further includes a longitudinal interior emitter plunger having a spiral wrapping affixed thereon such that the interior emitter plunger is configured to attach to the emitter bottom plug and be encased by the exterior emitter plunger.

In certain embodiments, the spiral wrapping is configured as a liquid path in which during operation liquid flows down the spiral wrapping and dispenses from the exterior emitter plunger along various points of a root zone within the plant growing medium.

In certain embodiments, the nozzle is configured to be barbed.

In certain embodiments, the nozzle is affixed to the top surface of the emitter top plug by ultrasonic welding.

In certain embodiments, the nozzle is interchangeable and is affixed to the top surface of the emitter top plug by snapping in the top surface.

In certain embodiments, the nozzle is cylindrically shaped and is configured with a conical shaped interior section for receiving a hose.

In certain embodiments, the nozzle is configured to be pierced.

In certain embodiments, the nozzle is configured to be T-shaped having a first side and a second side such that each side is barbed for receiving a hose.

In certain embodiments, the dripper is configured for use with a pressured fogger or humidifier of an irrigation feeding system.

Various advantages of this disclosure will become apparent to those skilled in the art from the following detailed description, when read in light of the accompanying drawings.

### BRIEF DESCRIPTION OF THE DRAWINGS

FIG. 1 is a perspective view of an exemplary embodiment of the irrigation apparatus setting on top of a plant growing medium according to the present disclosure.

FIG. 2 is a top perspective view of another exemplary embodiment of the irrigation apparatus as a standalone square top cover shown with a plug and a 90 degree emitter cap connected to a hose according to the present disclosure.

FIG. 3 is a top perspective view of the irrigation apparatus of FIG. 2 shown with a pair of 60 degree emitter caps connected to a hose according to the present disclosure.

FIG. 4 is a top plan view of another exemplary embodiment of the irrigation apparatus of FIG. 2 shown with a pair of over mold rings according to the present disclosure.

FIG. 5 is a cross-sectional view taken along the line 28-28 of the irrigation apparatus of FIG. 4.

FIG. 6 is an exploded top perspective view of an exemplary embodiment of a dripper according to the present disclosure.

FIG. 7 is an exploded top perspective view of another exemplary embodiment of a dripper according to the present disclosure.

FIG. 8 is an enlarged top perspective view of an exemplary embodiment of a nozzle for use with a dripper according to the present disclosure.

FIG. 9 is a cross-sectional view of the nozzle of FIG. 8 according to the present disclosure.

FIG. 10 is a top perspective view of a piercing nozzle for use with a dripper for piercing a hose according to the present disclosure.

FIG. 11 is a top plan view of a series of piercing nozzles affixed to a series of drippers from a single line of pressure of the hose source according to the present disclosure.

FIG. 12 is a top perspective view of a T-shaped nozzle for use with a dripper according to the present disclosure.

FIG. 13 is a top plan view of a series of T-shaped nozzles affixed to a series of drippers from a single line of pressure of the hose source according to the present disclosure.

### DETAILED DESCRIPTION

This disclosure is not limited to the particular systems, methodologies or protocols described, as these may vary. The terminology used in this description is for the purpose of describing the particular versions or embodiments only, and is not intended to limit the scope.

As used in this document, the singular forms “a,” “an,” and “the” include plural reference unless the context clearly dictates otherwise. Unless defined otherwise, all technical and scientific terms used herein have the same meanings as commonly understood by one of ordinary skill in the art. All publications mentioned in this document are incorporated by reference. All sizes recited in this document are by way of example only, and the invention is not limited to structures having the specific sizes or dimensions recited below. Nothing in this document is to be construed as an admission that the embodiments described in this document are not entitled to antedate such disclosure by virtue of prior invention. As used herein, the term “comprising” means “including, but not limited to.”

In consideration of the figures, it is to be understood for purposes of clarity certain details of construction and/or operation are not provided in view of such details being conventional and well within the skill of the art upon disclosure of the document described herein.

The following terms and phrases shall have, for purposes of this application, the respective meanings set forth below:

The terms “feeding” and “watering” are used interchangeably herein and are intended to have the same meaning with respect to the treating of a plant with liquid nutrition so that the plant may grow and flourish.

The terms “dripper” and “emitter” are used interchangeably herein and are intended to have the same meaning with respect to drip irrigation in assuring that a uniform rate of flow of liquid is achieved.

The term “irrigation” refers to the application of water to soil or another medium by artificial means to foster plant growth.

The terms “growing medium,” “medium,” or “media” refer to a liquid or solid in which organic structures such as plants are placed to grow.

The term “liquid” refers to any form of liquid nutrition for a plant, including water and the like.

The phrases “pressure compensating subsurface dripper or emitter” and “subsurface pressure compensating dripper or emitter” are used interchangeably herein and refer to a dripper or emitter that is forced into the growing medium while not compromising the flow of the drip by encasing the drip and not allowing anything to interfere with the dripper or emitter's set course.

The term “Rockwool” refers to the inorganic mineral based horticultural grade Rockwool primarily sold as a hydroponic substrate in the horticultural industry.

The phrase “substrate growing system” is a hydroponic system in which the root zone is physically supported by media and the plants are fed by applying nutrient solution to the media.

The irrigation apparatus and irrigation feeding system of the present disclosure pertains to a self-watering irrigation apparatus and feeding system that allows a user to measure the amount of water as it is distributed onto a plant instead of pre-measuring or doing a count; provides for a slow thorough and even distribution of water or other liquid nutrition; prevents algae, mold, and weeds from growing in the plant growing medium by covering the medium in its entirety; low cost to manufacture; fabricated from inexpensive materials; durable; and easy to assemble and disassemble, among other desirable features as described herein.

It is contemplated by the present disclosure that the irrigation apparatus and irrigation feeding system may be used with any suitable plant growing medium (e.g., Rockwool, soil, and the like) in a substrate growing system.

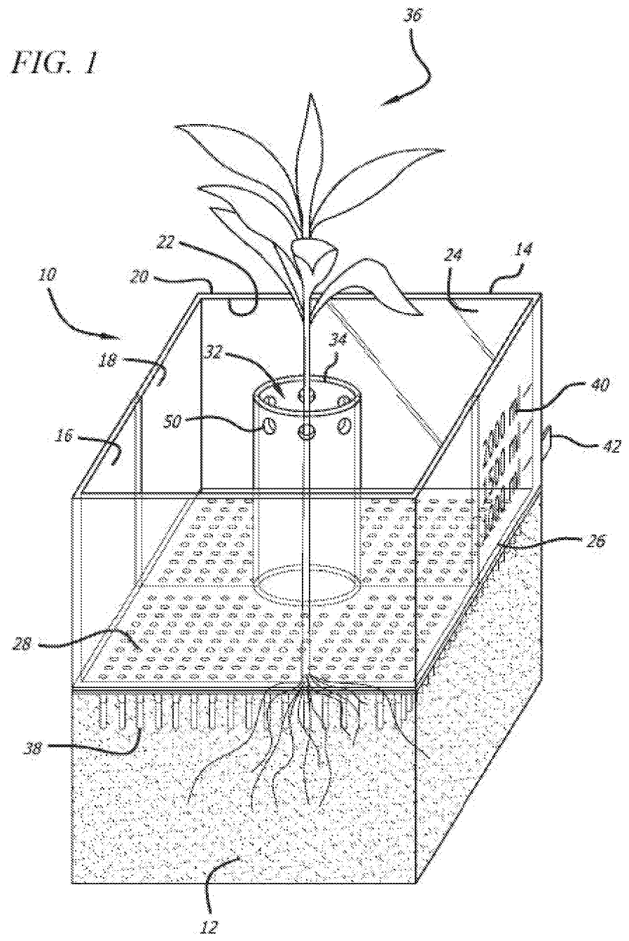

Referring now to FIG. 1 is a perspective view of an exemplary embodiment of the irrigation apparatus 10 setting on top of a plant growing medium 12 (e.g., Rockwool) according to the present disclosure. The irrigation apparatus 10 includes a geometrically shaped container 14 of variable size configured to be detachable in at least two pieces at a first side 16 and a second side 18. The container 14 has an outer wall 20 with an inner surface 22, an open top 24, and a base portion 26 configured to cover the plant growing medium 12. The base portion 26 is configured with a plurality of holes 28 for receiving liquid 30 therethrough.

As illustrated in FIG. 1, the container 14 is configured with at least one center opening 32 therethrough and includes an inner wall 34 for receiving a plant 36 when the first side 16 and the second side 18 of the container are adjoined together as a single container. The plurality of holes 28 are each configured with a dripper 38 for receiving liquid 30 extending therethrough the base portion 26 such that the dripper feeds the plant growing medium 12 at variable flow rates and intervals and provides stability for the apparatus 10 to be secured in the plant growing medium. It should be understood that the dripper may be configured to feed the plant growing medium at any suitable flow rate and interval in accordance with the present disclosure.

In accordance with the present disclosure, the geometrically shaped container 14 can be fabricated either as a single piece or as at least two separate pieces that are configured to be adjoined together at the first side 16 and the second side 18. The at least two piece configuration allows for easy installation or tear down of the container 14 by the user. In some embodiments, the first side 16 and the second side 18 are configured to be adjoined or secured together via at least a one male to one female ratio or other suitable combinations of male to female ratios, including, but not limited to, male to two female, two male to three female, or two male to two female, and the like. It should be understood that the first side 16 and the second side 18 may be adjoined or secured together via any suitable notch configured within the female and end of the male.

In one embodiment, the geometrically shaped container 14 can be a circle, cube, cylinder, conical, rectangle, square, or any other suitable geometrical shape. It should be understood that the container can be manufactured to suit any plant size growing medium and is sized to scale. For example, the container may be a cube with dimensions of 8 inches (height)×8 inches (width)×8 inches (length) and outer walls of 3/16 of an inch thick such that the container fits a Rockwool cube of same approximate dimensions.

The container may be fabricated of any sturdy material capable of retaining liquids or fluids (e.g., water), including metal, plastic, and the like.

In one embodiment, the geometrically shaped container 14 is transparent or clear having a measuring table 40 disposed thereon the inner surface 22, as illustrated in FIG. 1. It should be understood that the amount of volume each unit or container 14 can hold will be according to scale such that a plant growing in a 4 inches×4 inches×4 inches Rockwool cube does not require the same amount of liquid nutrition as a plant in a five gallon pot. For example, the measuring table 40 for a plant growing in an 8 inches×8 inches×8 inches Rockwool cube will allow up to approximately 2000 ml of liquid nutrition. Alternatively, the measuring table 40 for a plant growing in a 6 inches×6 inches×6 inches Rockwool cube will allow up to approximately 1200 ml of liquid nutrition.

In accordance with the present disclosure, the outer wall 20 of the container 14 may be configured with an adapter 42 for use with a hose 44 or pump 46 system, such that the irrigation apparatus 10 may be used in conjunction with the irrigation feeding system 48 disclosed herein. In some embodiments, the adapter 42 may be 0.5 inches in size with a cap for use with or without the irrigation feeding system or a hose or pump system that the user may wish to apply. It should be understood that the adapter can be of any type and size suitable for connecting the hose to the container.

In some embodiments, the container 14 is configured to include a plurality of variable size openings 50 disposed on the inner wall 34 for use as a flood drain for excess liquid retained in the container during feeding of the plant 36 to be directed to the center of the plant growing medium 12. It should be understood that the openings 50 disposed on the outer wall can be of any suitable size or dimension, preferably within the range of from about ⅛ of an inch to about one inch. In one embodiment, the openings are configured to be about ⅛ of an inch, such that excess liquid can flow therethrough and be directed to the areas where the plant requires additional moisture.

The at least one center opening 32 of the inner wall 34 for receiving the plant 36 may be circular (FIG. 1), conical, or cylindrical to accommodate various sizes of plants. It should be understood that the container 14 may be configured with multiple center openings to allow multiple plants to be received. In one embodiment, the at least one center opening 32 is fabricated to have about a two inch diameter, which enables the base of the plant 36 space to grow in the plant growing medium 12. It should be understood that the at least one center opening can be configured of any suitable size and is sized to scale relative to the size of the container.

The irrigation apparatus and irrigation feeding system of the present disclosure can be used with any suitable drippers or emitters, such as those with an extremely small hole in the tube (e.g., soaker hose, porous pipe, drip tape, laser tubing), those that work well on very low-pressure systems (e.g., short-path emitters), and those that are less likely to clog up (e.g., tortuous-path or turbulent-flow emitters).

Drippers or emitters are manufactured in a variety of different flow rates. The most common flow rates, suitable for use with the irrigation apparatus and irrigation feeding system of the present disclosure, include as follows:

2.0 liters/hour-½ gallon/hour

4.0 liters/hour-1 gallon/hour

8.0 liters/hour-2 gallons/hour

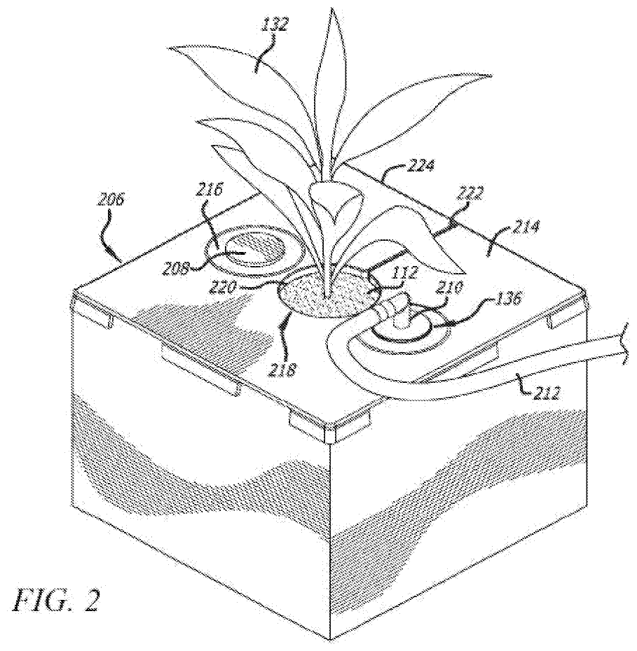

Referring now to FIG. 2 is a top perspective view of another exemplary embodiment of the irrigation apparatus as a standalone square top cover 206 shown with a plug 208 and a 90 degree emitter cap 210 connected to a hose 212 according to the present disclosure. In accordance with the present disclosure, the irrigation apparatus includes a geometrically shaped top 214 of variable size configured with a plurality of holes 216 for receiving liquid therethrough. The top 214 is configured with at least one center opening 218 therethrough having an inner wall 220 for receiving a plant 132. The at least one center opening 218 has at least one longitudinal opening 222 extending therefrom to an outer wall 224 to allow placement of the top 214 on the plant 132 or to allow removal of the top from the plant. The plurality of holes 216 are configured with at least one dripper 136 for receiving liquid extending therethrough the top 214 such that the at least one dripper feeds the plant growing medium 112 at variable flow rates and intervals and provides stability for the apparatus to be secured in the plant growing medium.

In some embodiments, the at least one dripper 136 is interchangeable and replaceable and includes a variable degree emitter cap 210 (e.g., 60 degree, 90 degree, etc.), a variable emitter path section 140 to control liquid flow, an emitter bottom 142, and an emitter plunger 144, which encases the drip and is secured in the plant growing medium 112.

In accordance with the present disclosure, a hose 212 is directly connected to the variable degree emitter cap 210 such that liquid can flow therethrough to the plant growing medium 112. It should be understood that the variable degree emitter cap 210, variable emitter path section 140, emitter bottom 142, and emitter plunger 144, can be used together as a single unit placed directly into the plant growing medium 112 without use of the geometrically shaped top 214 or any other unit or container 114 for dispersing liquid through the plant growing medium.

In further embodiments, the plurality of holes 216 not in use may be sealed with a plug 208 at top and bottom of the geometrically shaped top 214.

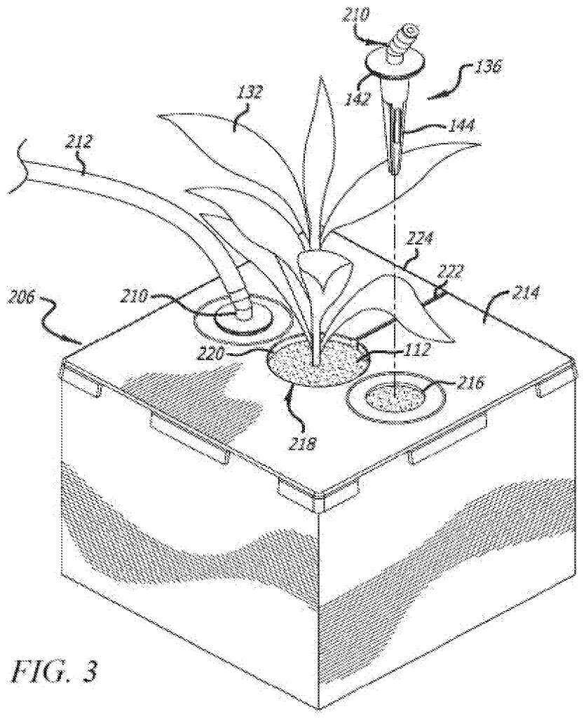

FIG. 3 is a top perspective view of the irrigation apparatus of FIG. 2 shown with a pair of 60 degree emitter caps 210 one of which is connected to a hose 212 according to the present disclosure.

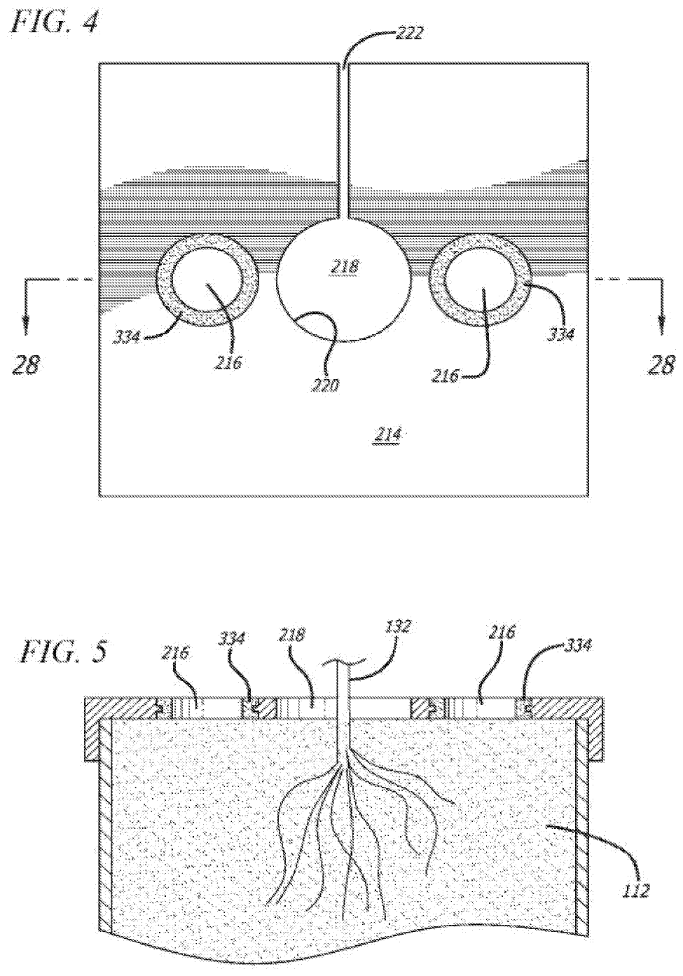

Referring now to FIG. 4 is a top plan view of another exemplary embodiment of the irrigation apparatus of FIG. 2 shown with a pair of over mold rings 334 according to the present disclosure. As previously disclosed herein, the irrigation apparatus includes a geometrically shaped top 214 of variable size configured with a plurality of holes 216 for receiving liquid therethrough. The top 214 is configured with at least one center opening 218 therethrough having an inner wall 220 for receiving a plant 132. The at least one center opening 218 has at least one longitudinal opening 222 extending therefrom to an outer wall 224 to allow placement of the top 214 on the plant 132 or to allow removal of the top from the plant. The plurality of holes 216 are configured with at least one dripper 136 (FIG. 2) for receiving liquid extending therethrough the top 214 such that the at least one dripper feeds the plant growing medium 112 at variable flow rates and intervals and provides stability for the apparatus to be secured in the plant growing medium.

As illustrated in FIG. 4, the plurality of holes 216 are each configured with an over mold ring 334 disposed therearound for providing an improved seal and interchangeability of the at least one dripper into the top 214 during use of the irrigation apparatus. The over mold rings 334 are separately molded and can be affixed to the geometrically shaped top 214 via conventional over-molding processes. It should be understood that the over mold rings can be fabricated from a rubber material or any suitable elastic polymeric material.

FIG. 5 is a cross-sectional view taken along the line 28-28 of the irrigation apparatus of FIG. 4 setting atop of the plant growing medium 112.

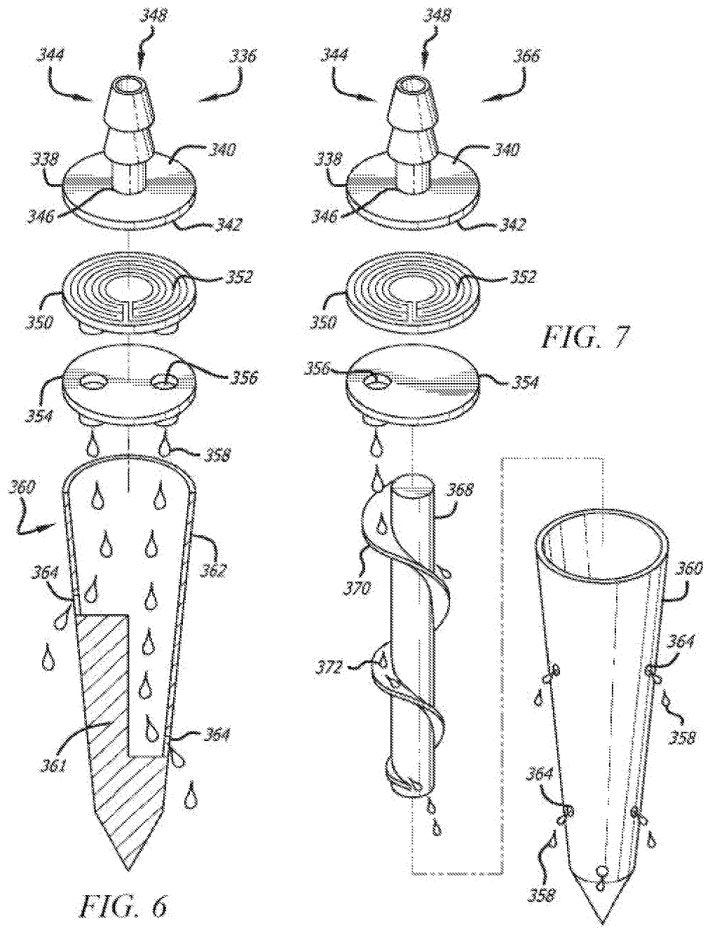

FIG. 6 is an exploded top perspective view and partial cross-sectional view of an exemplary embodiment of a dripper 336 for use with an irrigation feeding system for dispersing liquid through a plant growing medium according to the present disclosure. The dripper 336 includes an emitter top plug 338 having a top surface 340 and a bottom surface 342, a nozzle 344 having a first end 346 and a second end 348 such that the first end is configured to be affixed to the top surface of the emitter top plug, and a variable emitter path section 350 having at least one tortuous path 352 to control liquid flow. The dripper further includes an emitter bottom plug 354 having at least one hole 356 to discharge liquid 358 therefrom in which the emitter top plug 338 and the emitter bottom plug are configured to encase the variable path section 350, and a longitudinal exterior emitter plunger 360 having an outer surface 362 configured with a plurality of holes 364 for dispersing liquid 358 therethrough in which the exterior emitter plunger is configured to attach to the emitter bottom plug. It should be understood that the exterior emitter plunger 360 can be configured with or without a break section 361 inside the exterior emitter plunger for directing liquid to various points of the root zone within the plant growing medium.

Referring now to FIG. 7 is an exploded top perspective view of another exemplary embodiment of a dripper 366 according to the present disclosure. In addition to the structural features described above in FIG. 6, dripper 366 further includes a longitudinal interior emitter plunger 368 having a spiral wrapping 370 affixed thereon such that the interior emitter plunger is configured to attach to the emitter bottom plug 354 and be encased by the exterior emitter plunger 360. The spiral wrapping 370 is configured as a liquid path 372 in which during operation liquid 358 flows down the spiral wrapping and dispenses from the exterior emitter plunger 360 along various points of the root zone within the plant growing medium.

As an alternative to the embodiment of FIG. 7, the longitudinal interior emitter plunger 368 can have encased spiral tubing (not shown) configured for receiving liquid as a liquid path affixed thereon such that the interior emitter plunger is configured to attach to the emitter bottom plug 354 and be encased by the exterior emitter plunger 360. The encased spiral tubing (not shown) can be configured with a plurality of holes along the length thereof such that the plurality of holes are configured to be in alignment with the plurality of holes on the outer surface of the longitudinal exterior emitter plunger for dispersing liquid therethrough along various points of the root zone within the plant growing medium.

In some embodiments, the nozzle 344 is configured to be barbed 376, as illustrated in FIGS. 6 and 7.

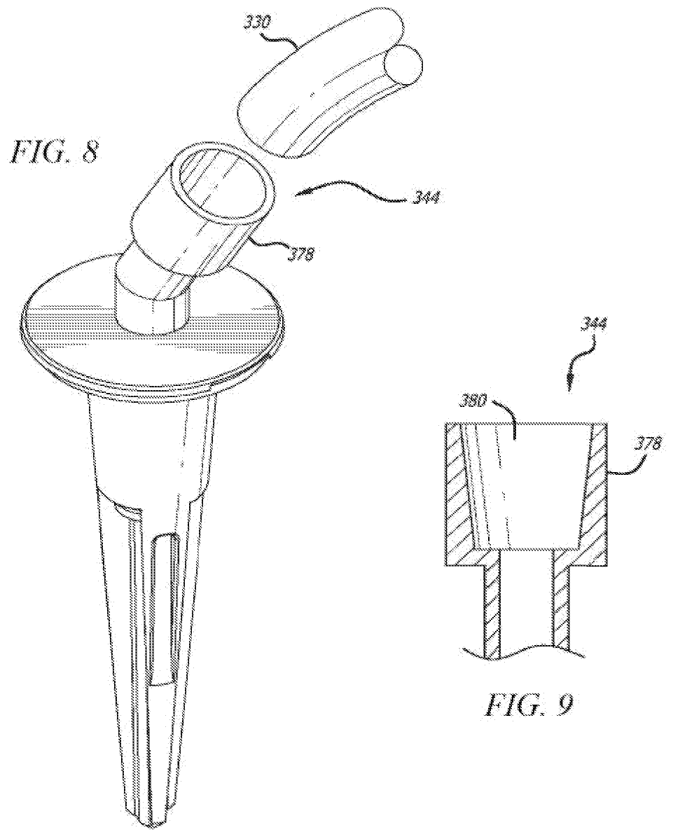

In some embodiments, the nozzle 344 is cylindrically shaped 378 and is configured with a conical shaped interior section 380 for receiving a hose 330, as illustrated in FIGS. 7 and 8.

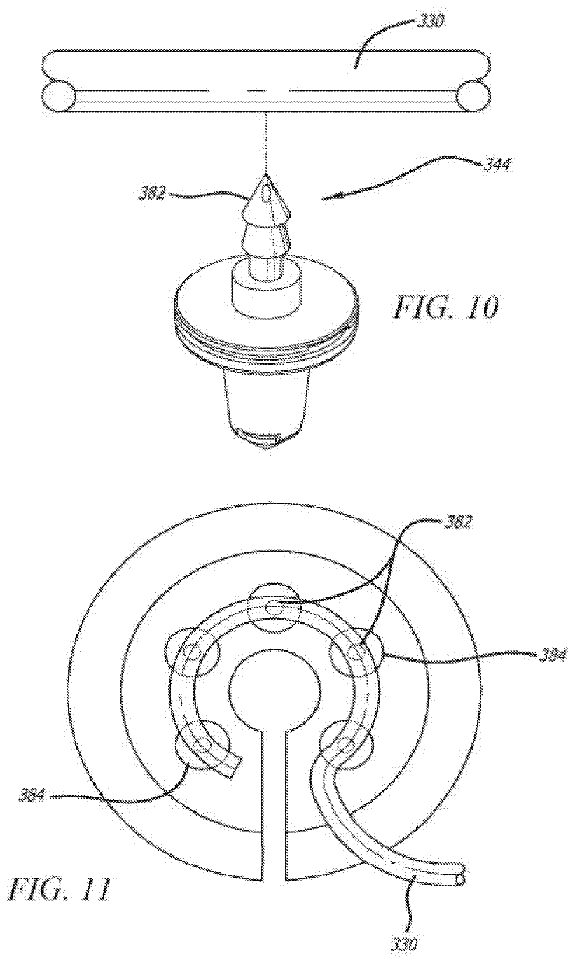

In some embodiments, the nozzle 344 is configured to be pierced 382 for piercing a hose 330, as illustrated in FIG. 9. FIG. 10 is a top plan view of a series of piercing nozzles 382 affixed to a series of drippers 384 from a single line of pressure of the hose source 330 via a pump (not shown) according to the present disclosure. It should be understood that any number of drippers may be used in series with the piercing nozzles according to the user's preferences.

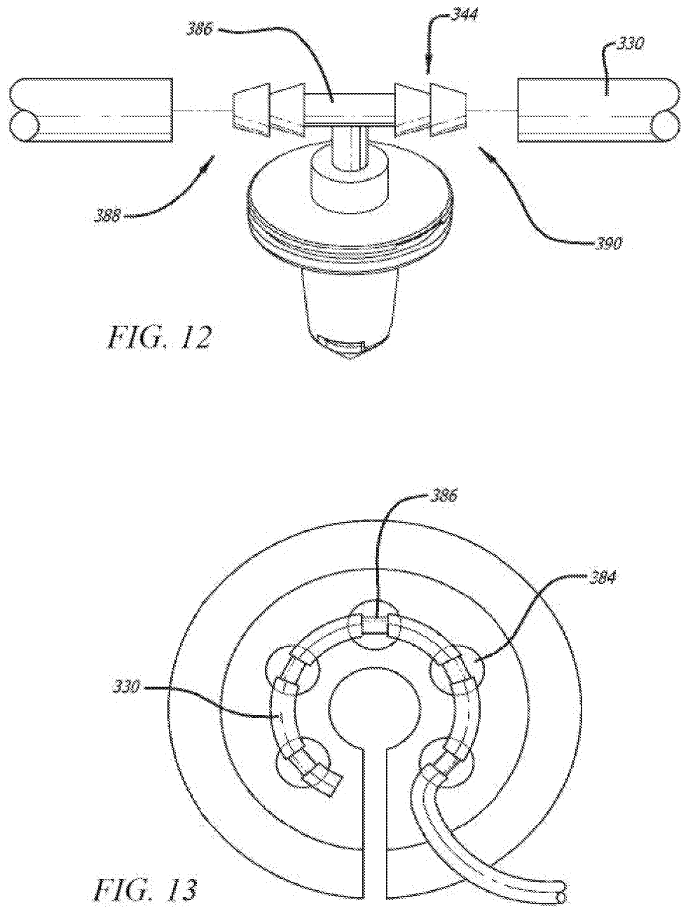

In some embodiments, the nozzle 344 is configured to be T-shaped 386 having a first side 388 and a second side 390 such that each side is barbed for receiving a hose 330, as illustrated in FIG. 11. FIG. 12 is a top plan view of a series of T-shaped nozzles 386 affixed to a series of drippers 384 from a single line of pressure of the hose source 330 via a pump (not shown) according to the present disclosure. It should be understood that any number of drippers may be used in series with the T-shaped nozzles according to the user's preferences.

It should be further understood that the various nozzles disclosed above in FIGS. 6-13 can be configured for use with any of the drippers previously disclosed herein. The nozzle can be fabricated of any suitable sturdy material, such as plastic, and can be molded as one piece affixed to the top surface 340 of the emitter top plug 338 by ultrasonic welding. In other embodiments, the nozzle is interchangeable and is affixed to the top surface 340 of the emitter top plug 338 by snapping in the top surface.

In accordance with the present disclosure, suitable flow rates for the drippers or emitters disclosed herein include as follows: 1/2, 1, 2, 4, 6, 8 and 10 gallons per hour. It is further contemplated in accordance with the present disclosure that the drippers or emitters disclosed herein can be used with any of the irrigation apparatuses (except irrigation apparatus 252 with the raised half-circles or louvers 266 in which no drippers or emitters are used) previously disclosed or can be used on their own without any irrigation apparatus according to the user's preferences.

Several of the features and functions disclosed above may be combined into different systems or applications, or combinations of systems and applications. Various presently unforeseen or unanticipated alternatives, modifications, variations or improvements therein may be subsequently made by those skilled in the art, each of which is also intended to be encompassed by the following claims.

What is claimed is:

1. An irrigation apparatus for dispersing liquid through a plant growing medium, the apparatus comprising:
a geometrically shaped container of variable size having an outer wall with an inner surface, an open top, and a base portion configured to cover the plant growing medium, wherein the base portion is configured with a plurality of holes for receiving liquid therethrough;
the container being configured with at least one center opening therethrough having an inner wall for receiving a plant, the at least one center opening having at least one longitudinal opening extending therefrom to the outer wall to allow placement of the container on the plant or to allow removal of the container from the plant;
wherein the container is configured with a. plurality of geometrically shaped stakes of variable size extending therefrom the base portion for providing stability for the apparatus to be secured in the plant growing medium;
wherein the plurality of holes is each configured with a dripper for receiving liquid extending therethrough the base portion, and the dripper comprising:
an emitter top plug having a top surface and a bottom surface;
a nozzle having a first end and a second end, wherein the first end is configured to be affixed to the top surface of the emitter top plug;
a variable emitter path section having at least one torturous path to control liquid flow;
an emitter bottom plug having at least one hole to discharge liquid therefrom, wherein the emitter top plug and the emitter bottom plug are configured to encase the variable emitter path section; and
a longitudinal exterior emitter plunger having an outer surface configured with a plurality of holes for dispersing liquid therethrough, wherein the exterior emitter plunger is configured to attach to the emitter bottom plug;
wherein the dripper feeds the plant growing medium at variable flow rates and intervals and provides stability for the apparatus to be secured in the plant growing medium,

2. The apparatus of claim 1, wherein the longitudinal exterior emitter plunger may be configured with a break section for directing liquid to various points of a root zone within the plant growing medium.

3. The apparatus of claim 1, further comprising: a longitudinal interior emitter plunger having a spiral wrapping affixed thereon, wherein the interior emitter plunger is configured to attach to the emitter bottom plug and be encased by the exterior emitter plunger.

4. The apparatus of claim 3, Wherein the spiral wrapping is configured as a liquid path in which during operation liquid flows down the spiral wrapping and dispenses from the exterior emitter plunger along various points of a root zone within the plant growing medium.

5. The apparatus of claim 1, wherein the nozzle is configured to be barbed.

6. The apparatus of claim 1, wherein the nozzle is affixed to the top surface of the emitter top plug by ultrasonic welding.

7. The apparatus of claim 1, wherein the nozzle is interchangeable and is affixed to the top surface of the emitter top plug by snapping in the top surface.

8. The apparatus of claim 1, wherein the nozzle is cylindrically shaped and is configured with a conical shaped interior section for receiving a hose.

9. The apparatus of claim 1, wherein the nozzle is configured to be pierced.

10. The apparatus of claim 1, wherein the nozzle is configured to be T-shaped having a first side and a second side such that each side is barbed for receiving a hose.

11. The apparatus of claim 1, wherein the dripper is configured for use with a pressured fogger or humidifier of an irrigation feeding system.
